(19) United States
(12) Patent Application Publication
(10) Pub. No.: US 2009/0292689 A1
(43) Pub. Date: Nov. 26, 2009

(54) SYSTEM AND METHOD OF PROVIDING ELECTRONIC DICTIONARY SERVICES

(75) Inventor: Sangyeop Lee, Seoul (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/128,125

(22) Filed: May 28, 2008

(30) Foreign Application Priority Data
May 20, 2008 (KR) 10-2008-46556

(51) Int. Cl. G06F 17/30

(52) U.S. Cl. 707/5; 707/E17.108

(57) ABSTRACT

A database and techniques for managing and updating the database are described. The database includes defined terms and undefined terms stored therein. While each of the defined terms is stored in the database in association with a definition thereof, each of the undefined terms is stored in the database in association with a number of times search requests have been received for the associated undefined term. Further, a ranking list for the undefined terms is maintained. In the ranking list, the undefined terms are ranked with reference to the number associated with each. Search requests for particular terms are received. In response to the search requests, the search for the particular term is performed in the database. If a match is found between a first one of the particular term and a first one of the defined terms, the definition thereof is retrieved from the database. Also, if a match is not found between a second one of the particular term and any of the defined terms, the ranking list is updated with reference to the second particular term.

### BACKGROUND OF THE INVENTION

The present invention generally relates to providing electronic dictionary services over a communication network such as the Internet.

Recently, on-line electronic dictionary services are in widespread use for retrieval of dictionary information such as definitions for a particular term. If a user comes across a term with an unknown or unfamiliar definition, then he or she can check its definition by simply connecting to such on-line services. Such on-line electronic dictionary services, however, are provided in a very limited way. That is, information stored in the electronic dictionary server is updated at a predetermined interval by a service provider so that the user must endure difficulties in obtaining information on definitions of newly coined, infrequently used, or unfamiliar terms. From the standpoint of the service provider, it may be a nuisance to update the data frequently in order to fulfill the needs of the user. Accordingly, conventional on-line electronic dictionary services are not able to provide sufficient and perfect data, thus being inevitably unsatisfactory to the users. An additional drawback associated with conventional on-line electronic dictionary services is that the user may have to login into a separate site (e.g., a portal site) from which electronic dictionary services are available.

### SUMMARY OF THE INVENTION

According to the present invention, various methods and apparatus relating to providing electronic dictionary services are provided. In accordance with one embodiment of the present invention, a database having defined terms and undefined terms stored therein is provided. While each of the defined terms is stored in the database in association with a definition thereof, each of the undefined terms is stored in the database in association with a number of times search requests have been received for the associated undefined term. Further, a ranking list for the undefined terms is maintained. In the ranking list, the undefined terms are ranked with reference to the number associated with each. Search requests for particular terms are received. In response to the search requests, the search for the particular term is performed in the database. If a match is found between a first one of the particular term and a first one of the defined terms, the definition thereof is retrieved from the database. Also, if a match is not found between a second one of the particular term and any of the defined terms, the ranking list is updated with reference to the second particular term.

In accordance with another embodiment of the present invention, a plurality of unregistered terms are stored. In such a case, each of the unregistered terms is stored in association with a number of times search requests have been received for the associated unregistered term. A ranking list for the unregistered terms is maintained. In the ranking list, the unregistered terms are ranked with reference to the number associated with each. A portion of the ranking list is provided to a requesting device. A registration request for first one of the unregistered terms in the ranking list from the requesting device is received. In response to the registration request, the first unregistered term is registered.

In accordance with another embodiment of the present invention, there is provided a system for providing electronic dictionary services. The system comprises a first database, a second database, a ranking management module and a search module. The first database stores a plurality of defined terms, each defined term being stored in association with a definition thereof. The second database stores a plurality of undefined terms, each of the undefined terms being stored in association with a number of times search requests have been received for the associated undefined term. The ranking management module is configured to maintain a ranking list for the undefined terms. In the ranking list, the undefined terms are ranked with reference to the number associated with each. The search module is configured to respond to a search request for a particular term by searching at least one of the first and second databases for the particular term and generating a search result. The ranking management module is further configured to update the ranking list based on the search result.

In accordance with another embodiment of the present invention, there is provided a system for providing electronic dictionary services. The system includes a first database, a second database, a ranking management module and a registration module. The first database stores a plurality of defined terms, each defined term being stored in association with a definition thereof. The second database stores a plurality of undefined terms, each of the undefined terms being stored in association with a number of times search requests have been received for the associated undefined term. The ranking management module is configured to maintain a ranking list for the undefined terms. In the ranking list, the undefined terms are ranked with reference to the number associated with each. The registration module is configured to respond to a registration request for a particular term by storing the particular term in the first database. The ranking management module is further configured to update the ranking list in response to the registration request.

In accordance with another embodiment of the present invention, there is provided a method of facilitating registration of terms in a terminology collection. According to the method, a first interface relating to the terminology collection is presented. The first interface includes a portion of a ranking list of unregistered terms whose definitions are not included in the terminology collection. The unregistered terms in the list are ranked with reference to a number of times search requests have been received for each of the unregistered terms. Then, a first mechanism accessible via the first interface by which a registration request for a first one of the unregistered terms in the ranking list may be initiated is provided.

A further understanding of the nature and advantages of the present invention may be realized by reference to the remaining portions of the specification and the drawings.

### BRIEF DESCRIPTION OF THE DRAWINGS

FIG. 1 shows a network configuration including an electronic dictionary service system in accordance with one embodiment of the present invention.

FIG. 2 shows a flow chart illustrating the process to provide electronic dictionary services according to one embodiment of the present invention.

FIG. 3 illustrates an example of the main page.

FIG. 4 shows a window transferred to the user when clicking the “See More” button in FIG. 3.

FIG. 5 shows a flow chart illustrating a search process in accordance with one embodiment of the present invention.

FIG. 6 shows an example of the search result page.

FIG. 7 shows another example of the search results page.

FIG. 8 shows a flow chart explaining a registration process in accordance with one embodiment of the present invention.

FIG. 9 shows an example of the registration page.

FIG. 10 shows an example of the registration result page.

FIG. 11 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

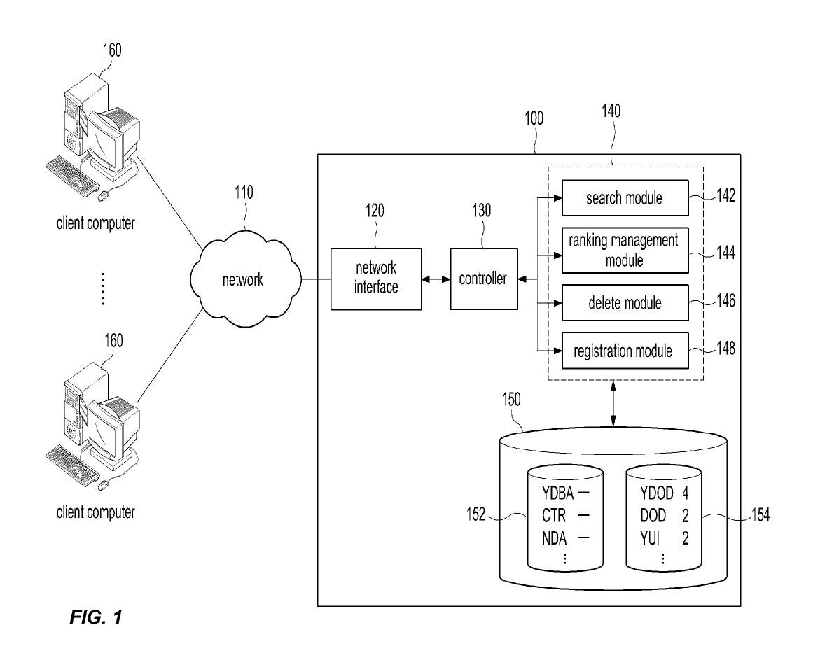

FIG. 1 shows a network configuration including a system of providing electronic dictionary services (“electronic dictionary service system”) in accordance with one embodiment of the present invention. In a particular embodiment of the present invention, the electronic dictionary service refers to services providing a definition of a term that a user requests through the network. Given that newly coined words increase from day to day, such a service would be useful for a user who comes across a term with an unknown or unfamiliar definition.

As shown in FIG. 1, a plurality of client computers 160 is placed in communication by network 110 to the electronic dictionary service system 100. The network 110 is preferably the Internet or other similar wide area network, which is provided by one or more telecommunications companies and allows a client computer 160 to access the electronic dictionary service system 100 over a wide geographic area. The client computer 160 may be a laptop, notebook, desktop or other types of computing device, as well as a personal digital assistant (PDA) device, a mobile or cellular telephonic device or the like.

The electronic dictionary service system 100 may include a network interface 120 designed to transfer communications between the client computer 160 and a dictionary service server 140 in a reciprocal way. The network interface transfers user requests and the results of user requests between the client computer 160 and the dictionary service server 140. The network interface 120 is constructed to implement a suitable communication protocol between the client computer 160 and the electronic dictionary service system 100. In a particular embodiment, the Representational State Transfer (REST) architectural style or Simple Object Access Protocol (SOAP) may be implemented. Further, in various embodiments, the TCP or UDP protocol may be implemented. In a particular embodiment, and in accordance with the request from the network interface 120, a controller 130 manages operation of the dictionary service server 140. The controller 130 controls the particular operations of each module of the dictionary service server 140, which is explained below, and transfers the results from each module to the network interface 120.

The electronic dictionary service system 100 may further include a database 150. When referring to FIG. 1, the database 150 comprises a term DB 152 storing terms, the definitions of which are already registered (“defined terms”), and a ranking DB 154 storing terms for which definitions have not been registered (“undefined terms”). While each defined term is stored with a definition thereof in the term DB 152, each undefined term is stored with the number of times of receiving search requests therefor (“search request number”) from the client computers 160 in the ranking DB 154. In one class of embodiments of the present invention, the term DB 152 and the ranking DB 154 may be constructed by using an open/commercial RDBMS (Relational DataBase Management System). In such a case, if the term DB 152 and the ranking DB 154 are constructed by using the RDBMS, then the term DB 152 and the ranking DB 154 search and sort out the data by using the search function and sort function, which are implemented within the RDBMS. Further, although the database 150 is illustrated as being separately constructed outside of the dictionary service server 140, one of ordinary skill in the art would appreciate that the database 150 can be installed inside of the dictionary service server 140.

The electronic dictionary service system 100 may further include the dictionary service server 140. The dictionary service server 140 manages the database 150 in accordance with the control from the controller 130. The dictionary service server 140 may further include a search module 142, ranking management module 144, delete module 146, and registration module 148.

The search module 142 searches the database in response to receiving the search request from the controller 130. The search module 142 searches at least one of the term DB 152 and ranking DB 154. In one embodiment of the present invention, the search module 142 may first search the term DB 152, and if a corresponding search result does not exist in the term DB 152, then may further search the ranking DB 154. In a particular embodiment, if the database 150 is constructed by using the RDBMS, then the search module 142 inquires whether the term for which the search request is received from the client computer 160 exists in the database 150 by using the SQL (Structured Query Language), thereby performing the search. The search results obtained by the search module 142 are reported to the controller 130. The controller 130 provides the search results to the client computer 160 through the network interface 120.

The ranking management module 144 may be operated by the controller 130 when a search request or registration request associated with an undefined term is received. Based on the search or registration request, the ranking management module 144 modifies the data stored in the ranking DB 154 and updates the ranking list. In particular, the ranking management module 144 counts the search request numbers for each undefined term and stores the numbers in the ranking DB 154. Further, the ranking management module 144 prepares a ranking list indicating for which undefined terms search requests are received most based on the data stored in the ranking DB 154. According to some embodiments of the present invention, the ranking list enables a user to directly recognize the undefined terms for which search requests are most received so that if there exists a term, the meaning of which is known to the user, he/she can register the definition correctly. That is, the ranking list functions to lead a user who knows the definition of a particular term included in the ranking list to register the definition quickly so that other users can also know the definition.

The registration module 148 may be operated by the controller 130 when the controller 130 receives the request for registering the definition of a particular term. The registration module 148 stores the particular term with its definition in the term DB 152. Prior to storing the term in the term DB 152, the registration module 148 determines whether the term is already stored in the term DB 152. If the term is found to be already stored in the term DB 152, then the registration module 148 adds the newly proposed definition of the term to the term DB 152. Also, if the term is not found to be stored in the term DB 152, then the registration module 148 reports to the controller 130 an occurrence of the event that the undefined term is newly registered.

When it is reported to the controller that the undefined term is newly registered, the controller 130 calls the delete module 146. The delete module 146 deletes the newly registered term from the ranking DB 154. In such a case, the changes of the data in the ranking DB 154 are caused by the delete operation. Thus, after the delete module 146 deletes the term from the ranking DB 154, the ranking management module 144 updates the ranking list based on the data currently stored in the ranking DB 154. As such, the term with the registered definition is deleted from the ranking list.

The specific procedures according to one embodiment of the invention between the electronic dictionary service system 100 and a client computer 160 for providing electronic dictionary services are explained below in more detail.

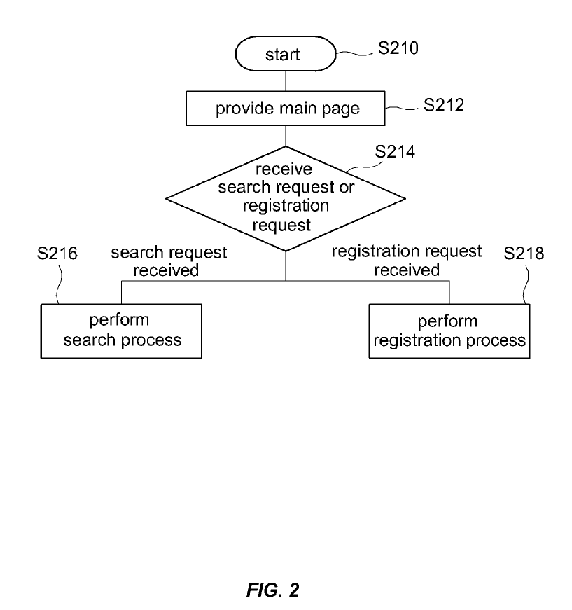

FIG. 2 provides a flow chart illustrating a process to provide electronic dictionary services according to one embodiment of the present invention. In FIG. 2, the electronic dictionary services are provided in the form of a messenger plug-in in accordance with one embodiment of the present invention. That is, the electronic dictionary services are provided in combination with one of the messenger programs used by the user. For example, the Yahoo! Messenger service is designed to allow a user to implement an additional function in person. Thus, there exist various plug-ins (additional functions) for Yahoo! Messenger. Further, the documents explaining methods for interlocking Yahoo! Messenger with an additional function implemented in the plug-in type are provided for a developer who wants to add a particular plug-in to Yahoo! Messenger (http://developer.yahoo.com/messenger, http://gallery.yahoo.com/messenger, etc.). Thus, one of ordinary skill in the art can understand that electronic dictionary services enabled by the present invention may be combined with the Yahoo messenger by using a suitable technology.

At the step 210 of FIG. 2, the process of providing electronic dictionary services is initiated. In particular, the services are started in a manner in which a user logs in to the messenger program that provides the plug-in function for electronic dictionary services. By clicking the corresponding function button in the logged-in messenger interface, the user may be provided with the electronic dictionary services. At the step 212, the dictionary service server 140 provides a main page of the terminology collection service to the user.

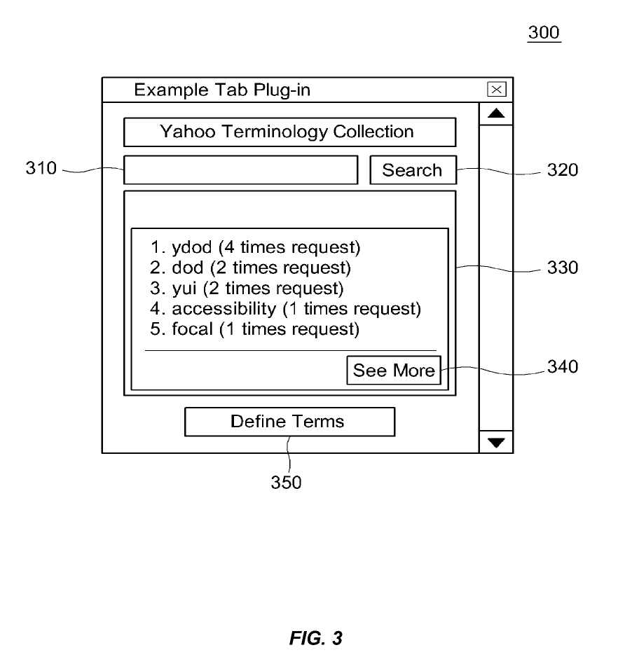

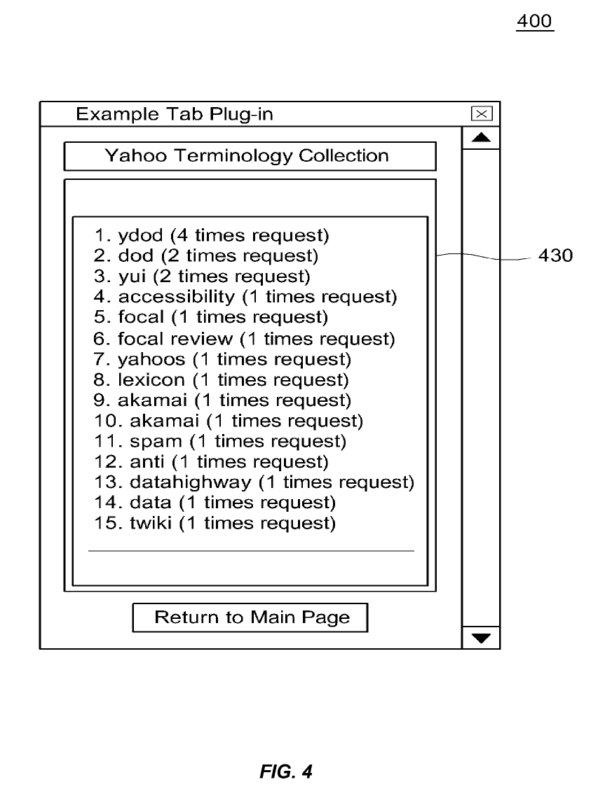

FIG. 3 illustrates an example of the main page 300. The main page 300 includes the window for inputting a term 310, search button 320, ranking box 330, “See More” button 340, and “Define Terms” button 350. The ranking box 330 provides a ranking list indicating undefined terms for which the most search requests are received based on the data stored in the ranking DB 154. Although only five terms, which are ranked No. 1 to No. 5, are displayed at the ranking box 330 in FIG. 3, if the user clicks the “See More” button 340, additional terms or a wider range of terms (e.g., 6-10, 1-15, etc.) are provided to the user. FIG. 4 shows a window 400 transferred to the user in response to clicking the “See More” button 340. In FIG. 4, the terms corresponding to No. 1 to No. 15 are displayed at the ranking box 430. Through the ranking list, the user can recognize for which terms other users make the most inquires. Further, if the ranking list includes a term with a familiar or known definition to the user, then the user is motivated to register the definition of the term correctly. That is, ranking boxes 330 and 340 encourage a user to participate in defining a term for which other users want to know the definition. In this way, a community of messenger users can collectively participate in defining the terms through the ranking list. According to some embodiments, it is possible for a service provider to effectively collect information on the definitions of the terms in an interactive manner.

Referring back to FIG. 3, when a user inputs a particular term with an unfamiliar definition into the input window 310 and clicks the search button 320, the search request is transferred to the dictionary service server 140. The search request is received at the step 214 of FIG. 2. In response to the search request, the search process may be performed at the step 216. Further, a user may click the “Define Terms” button 350 in the main page 300 instead of clicking the search button 320. In such a case, the registration request is transferred to the dictionary service server 140. Thus, the registration process may be performed at the step 218.

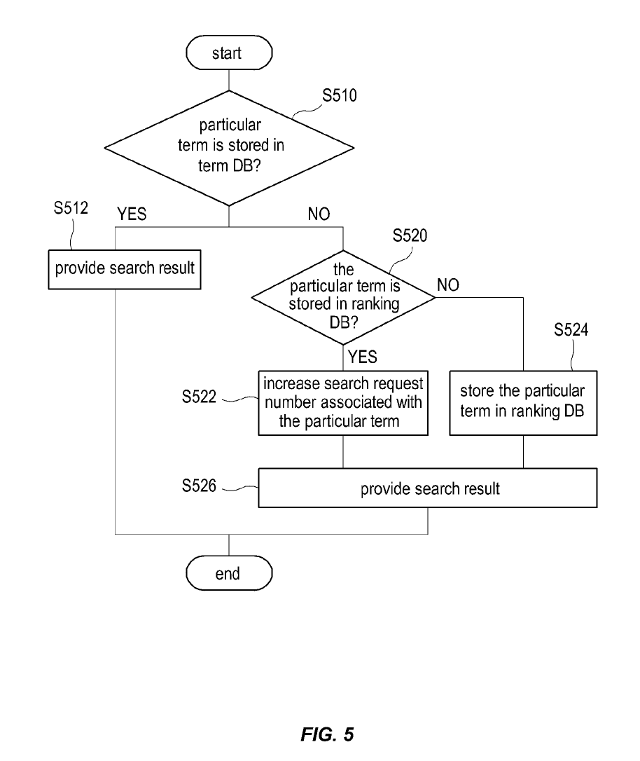

FIG. 5 shows a flow chart illustrating a search process in accordance with one embodiment of the present invention.

The dictionary service server 140, which receives a search request for a particular term, determines whether the particular term is stored in the term DB 152 at the step 510. If the particular term is determined to be stored in the term DB 152, then the dictionary service server 140 extracts the definition of the term from the term DB 152 and provides it to the user at the step 512.

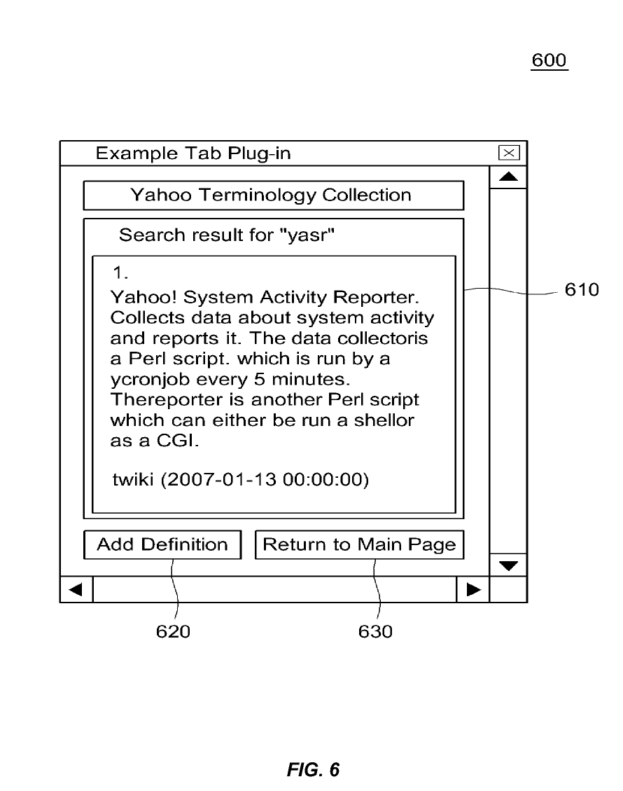

FIG. 6 shows an example of the search result page 600 provided to the user. Referring to FIG. 6, the search result page 600 includes the search result window 610, “Add Definition” button 620, and “Return to Main Page” button 630. As one example, in FIG. 6, the definition of the term “yasr” is provided in the search result window 610. If the user is aware of another definition of the term “yasr,” then the user can add another definition of the term “yasr” by clicking the “Add Definition” button 620. If the user clicks the “Add Definition” button 620, then the registration process proceeds, which is explained below. If the user clicks the “Return to Main Page” button 630, then the main page 300 shown in FIG. 3 is provided once again to the user.

Returning to FIG. 5, if the particular term is determined to be not stored in the term DB 152 at the step 510, then the search module 142 may further determine at the step 520 whether the particular term is stored in the ranking DB 154. As a result of the determination at the step 520, if the term is found to be stored in the ranking DB 154, then the ranking management module 144 increases the search request number associated with the particular term at the step 522. That is, the search request number for the particular term would be increased by one according to the present search request. The increased search request number for the particular term is stored in the ranking DB 154.

Further, if the term is not found to be stored in the ranking DB 154 at the step 520, then the ranking management module 144 stores the particular term with its search request number in the ranking DB 154 at the step 524. In such a case, the search request number for the particular term would be “1.” After the steps 522 and 524, the process proceeds to the step 526 where the search result that the particular term is not defined is provided to the user.

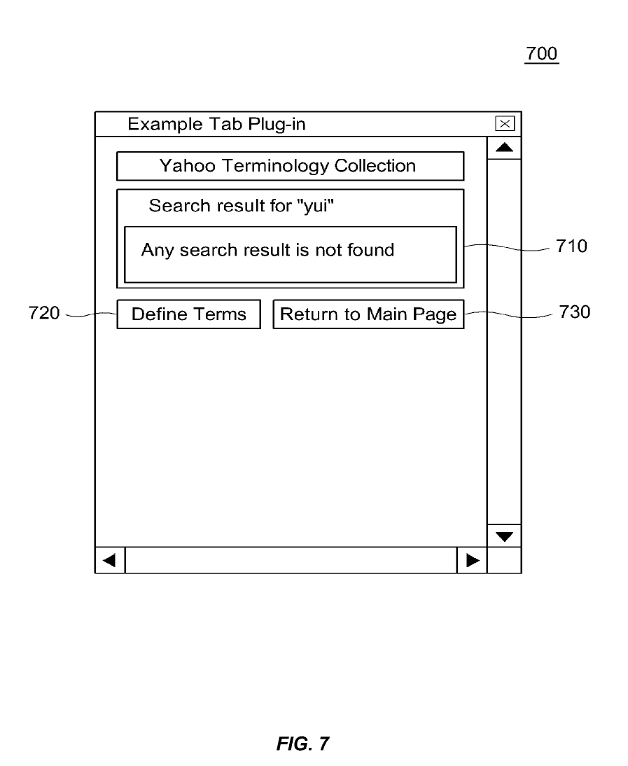

FIG. 7 shows one example of the search result page 700, which is provided to the user at the step 526. In the search result window 710, it is indicated that the corresponding search result is not found. The “Define Terms” button 720 and the “Return to Main Page” button 730 are provided below the search result window 710 in FIG. 7. The “Define Terms” button 720 performs the same operation as the “Define Terms” button 340 included in the main page 300 of FIG. 3. That is, if a user clicks the “Define Terms” button, then the following registration process proceeds.

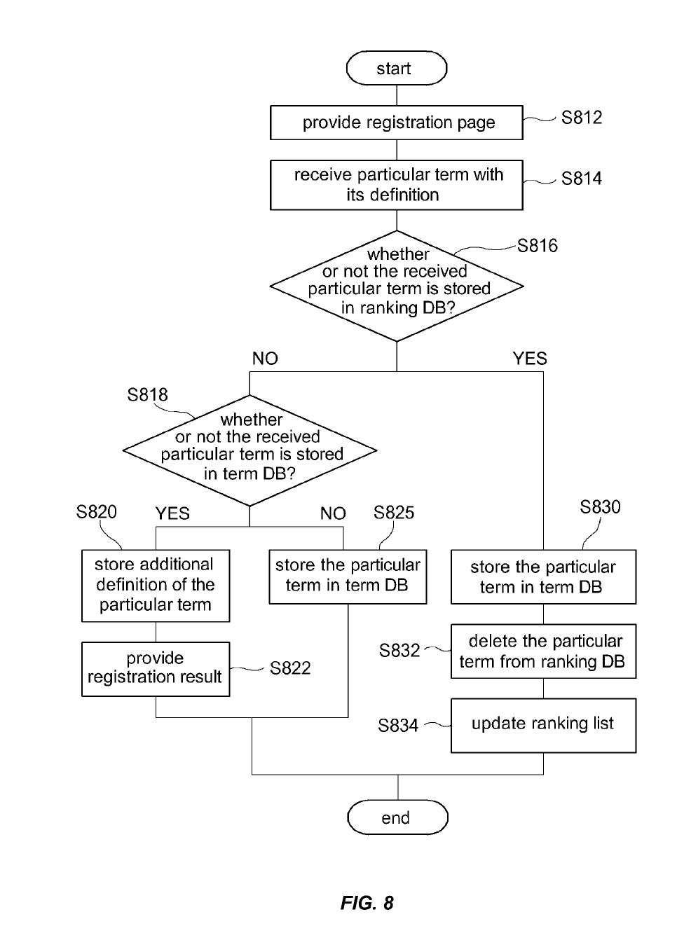

FIG. 8 shows a flow chart explaining a registration process in accordance with one embodiment of the present invention.

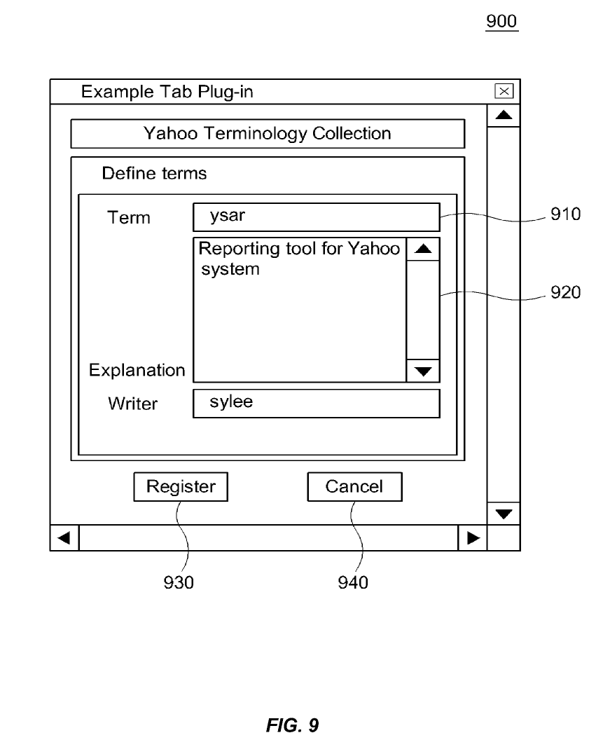

The dictionary service server 140, which receives the registration request from the user, provides a registration page to the user. FIG. 9 shows an example of the registration page 900. Referring to FIG. 9, the registration page 900 includes the window for inputting a particular term 910, window for inputting a definition of a particular term 920, “Register” button 930, and “Cancel” button 940. The user enters a particular term in the input window 910 and enters the definition of the particular term in the explanation window 920. Then, if the user clicks the “Register” button 930, the dictionary service server 140 receives the particular term with its definition at the step 814. Thereafter, the dictionary service server 140 determines whether or not the received particular term is stored in the ranking DB 154 at the step 816.

If the determination result at the step 816 indicates that the particular term is stored in the ranking DB 154, then the process proceeds to the step 830 wherein the registration module 148 stores the term and its definition in the term DB 152. Then, the delete module 146 deletes the term from the ranking DB 154 at the step 832. In response to a change of the data stored in the ranking DB 154 by the delete module 146, the ranking management module 144 updates the ranking list based on the current data stored in the ranking DB 154 at the step 834.

If a particular term is found not to be included in the ranking DB 154 at the step 816, then the process proceeds to the step 818 wherein a determination is made as to whether or not the received particular term is stored in the term DB 152. If the particular term is found to be included in the term DB 152, then the registration request is regarded as a request for registering an additional definition of the particular term. In such a case, the registration module 148 stores the additional definition of the particular term in the term DB 154 at the step 820. Thereafter, the dictionary service server 140 provides the registration result page to the user at the step 822. The user can confirm whether or not the definition of the particular term is correctly registered. Further, as to the case of registering the additional definition of the particular term, the user can check whether the additional definition of the particular term duplicates the previously registered definition.

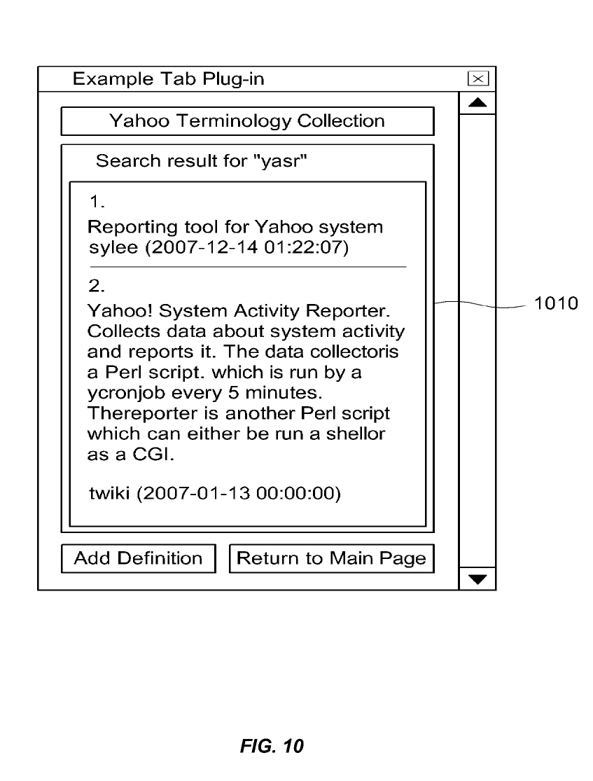

FIG. 10 shows an example of the registration result page, which is provided to the user at the step 822. The registration result window 1010 includes two definitions (“Definition 1” and “Definition 2”) of the term “yasr.” If the additionally registered definition (Definition 2) duplicates the previously registered definition (Definition 1), then the user is allowed to delete the additionally registered definition by himself/herself using a delete button (not shown).

Referring back to FIG. 8, if it is determined at the step 818 that the particular term is not stored in the term DB 152, then it signifies that the particular term has never been stored in the electronic dictionary service system and the definition should be registered for the first time. Then, the registration module 148 stores the term in the term DB 152 at the step 825.

While the methods and systems of providing electronic dictionary services have been described above as being provided in the messenger plug-in type in one embodiment, it should be expressly stated herein that the present invention is not limited thereto and can be provided as various types such as Widget, Wiki, PC software, web page, etc. Further, some or all of the elements or operations of the methods and systems of providing the terminology collection may be implemented using a computer system having general purpose hardware architecture.

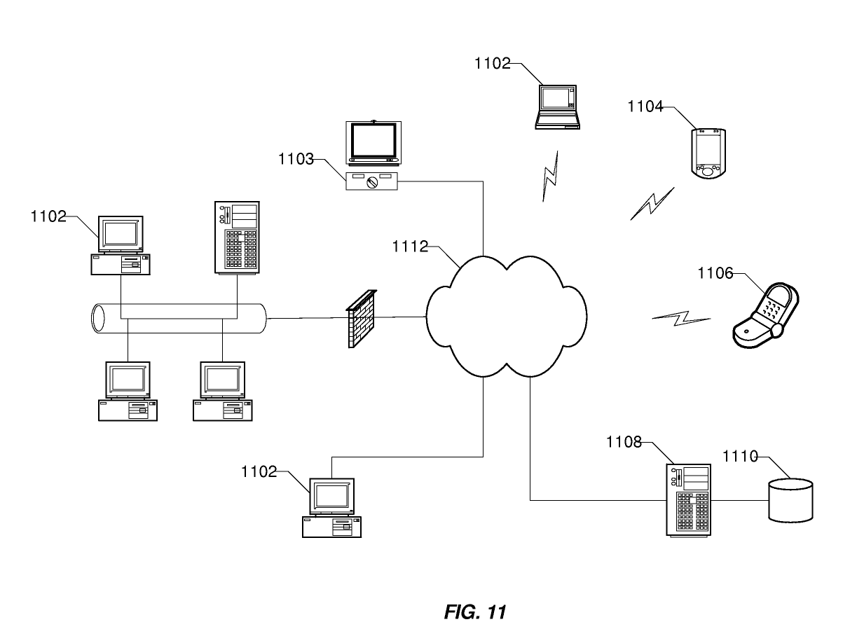

Embodiments of the present invention may be employed to provide and enhance electronic dictionary services in any of a wide variety of computing contexts. For example, as illustrated in FIG. 11, implementations are contemplated in which the relevant population of users interacts with a diverse network environment via any type of computer (e.g., desktop, laptop, tablet, etc.) 1102, media computing platforms 1103 (e.g., cable and satellite set top boxes and digital video recorders), handheld computing devices (e.g., PDAs, email clients, etc.) 1104, cell phones 1106, or any other type of computing or communication platform.

As will be understood, the various processes and services enabled by embodiments of the invention may be provided in a centralized manner. This is represented in FIG. 11 by server 1108 and data store 1110 which, as will be understood, may correspond to multiple distributed devices and data stores. Dictionary services may then be provided to users in the network via the various channels with which the users interact with the network.

The various aspects of the invention may also be practiced in a wide variety of network environments (represented by network 1112) including, for example, TCP/IP-based networks, telecommunications networks, wireless networks, etc. In addition, the computer program instructions and data structures with which embodiments of the invention are implemented may be stored in any type of computer-readable media, and may be executed according to a variety of computing models including, for example, a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method of providing electronic dictionary services, comprising:
providing a database having defined terms and undefined terms stored therein, each of the defined terms being stored in the database in association with a definition thereof, and each of the undefined terms being stored in the database in association with a number of times search requests have been received for the associated undefined term;
maintaining a ranking list for the undefined terms in which the undefined terms are ranked with reference to the number associated with each;
receiving search requests for particular terms;
searching the database for the particular terms; and
if a match is found between a first one of the particular terms and a first one of the defined terms, retrieving the definition associated with the first defined term from the database, and if a match is not found between a second one of the particular terms and any of the defined terms, updating the ranking list with reference to the second particular term.

2. The method of claim 1, wherein updating the ranking list with reference to the second particular term includes:
if the second particular term is stored in the database as one of the undefined terms, increasing the associated number.

3. The method of claim 1, wherein updating the ranking list with reference to the second particular term includes:
if the second particular term is not stored in the database as one of the undefined terms, storing the second particular term in the database as one of the undefined terms.

4. A method of providing electronic dictionary services, comprising:
storing a plurality of unregistered terms, each of the unregistered terms being stored in association with a number of times search requests have been received for the associated unregistered term;
maintaining a ranking list for the unregistered terms in which the unregistered terms are ranked with reference to the number associated with each;
providing a portion of the ranking list to a requesting device;
receiving a registration request for a first one of the unregistered terms in the ranking list from the requesting device; and
registering the first unregistered term.

5. The method of claim 4, wherein registering of the first unregistered term includes:
if the first unregistered term is found to be already stored, deleting storage information corresponding to the first unregistered term.

6. The method of claim 5, further comprising:
updating the ranking list after deleting the storage information corresponding to the first unregistered term.

7. The method of claim 4, wherein registering the first unregistered term includes storing of the first unregistered term in association with a definition thereof.

8. A system for providing electronic dictionary services, comprising:
a first database storing a plurality of defined terms, each defined term being stored in association with a definition thereof;
a second database storing a plurality of undefined terms, each of the undefined terms being stored in association with a number of times search requests have been received for the associated undefined term;
a ranking management module configured to maintain a ranking list for the undefined terms in which the undefined terms are ranked with reference to the number associated with each; and
a search module configured to respond to a search request for a particular term by searching at least one of the first and second databases for the particular term and generating a search result,
wherein the ranking management module is further configured to update the ranking list based on the search result.

9. The system of claim 8, wherein the ranking management module is further configured to update the ranking list if the particular term is not found in the first database.

10. The system of claim 9, wherein the ranking management module is further configured to increase the number associated with the particular term in the second database if the particular term is found in the second database.

11. The system of claim 9, wherein the ranking management module is further configured to store the particular term in the second database if the particular term is not found in the second database.

12. A system for providing electronic dictionary services, comprising:
a first database storing a plurality of defined terms, each defined term being stored in association with a definition thereof;
a second database storing a plurality of undefined terms, each of the undefined terms being stored in association with a number of times search requests have been received for the associated undefined term;
a ranking management module configured to maintain a ranking list for the undefined terms in which the undefined terms are ranked with reference to the number associated with each; and
a registration module configured to respond to a registration request for a particular term by storing the particular term in the first database,
wherein the ranking management module is further configured to update the ranking list in response to the registration request.

13. The system of claim 12, further comprising:
a delete module configured to delete the particular term from the second database in response to the registration request if the particular term is found in the second database.

14. The system of claim 13, wherein the ranking management module is further configured to update the ranking list to reflect deletion of the particular term from the second database.

15. The system of claim 12, wherein the registration module is further configured to store the particular term in the first database in association with a definition thereof.

16. A method of facilitating registration of terms in a terminology collection, comprising:
presenting a first interface relating to the terminology collection, the first interface including a portion of a ranking list of unregistered terms with definitions not included in the terminology collection, the unregistered terms in the list being ranked with reference to a number of times search requests have been received for each of the unregistered terms; and
providing a first mechanism accessible via the first interface by which a registration request for a first one of the unregistered terms in the ranking list may be initiated.

17. The method of claim 16 further comprising providing a second mechanism accessible via the first interface by which other portions of the ranked list may be accessed.

18. The method of claim 16 wherein the first mechanism is configured to enable entry of a definition for the first unregistered term in conjunction with the registration request.
